(19) United States
(12) Patent Application Publication
(10) Pub. No.: US 2025/0235952 A1
(43) Pub. Date: Jul. 24, 2025

(54) BROADBAND EMITTERS FOR THERMAL RADIATIVE ENERGY TRANSPORT

(71) Applicant: The Regents of the University of California, Oakland, CA (US)

(72) Inventors: Minok Park, Emeryville, CA (US); Vassilia Zorba, Kensington, CA (US); Costas P. Grigoropoulos, Berkeley, CA (US); Sean Lubner, Cambridge, MA (US); Ravi S. Prasher, Danville, CA (US)

(21) Appl. No.: 19/021,601

(22) Filed: Jan. 15, 2025

Related U.S. Application Data
(60) Provisional application No. 63/623,424, filed on Jan. 22, 2024.

(51) Int. Cl. B23K 26/0622; B23K 26/08; B23K 26/352; G02B 5/00

(52) U.S. Cl. CPC B23K 26/0624; B23K 26/0853; B23K 26/3584; G02B 5/003

(57) ABSTRACT

This disclosure provides systems, methods, and apparatus related to broadband emitters. In one aspect, a method includes providing a material. A pulse fluence, a wavelength, a repetition rate, and a pulse duration of a laser pulse are specified, and a number of laser pulses are specified. The material is exposed to the specified number of laser pulses at the pulse fluence, the wavelength, the repetition rate, and the pulse duration. The material is translated and the exposing operation is repeated to form an x-y array of exposed areas on the material. Each exposed area is about 25 microns to 35 microns from each other exposed area.

### RELATED APPLICATIONS

This application claims priority to U.S. Provisional Patent Application No. 63/623,424, filed Jan. 22, 2024, which is herein incorporated by reference.

### STATEMENT OF GOVERNMENT SUPPORT

This invention was made with government support under Contract No. DE-AC02-05CH11231 awarded by the U.S. Department of Energy. The government has certain rights in this invention.

### BACKGROUND

Thermal radiative energy transport, occurring in the visible to infrared spectral range, plays a role in many energy harvesting and storage as well as thermal management applications, such as thermophotovoltaics, passive radiative cooling, concentrating solar power, spacecraft, and solar water desalination. Spectral absorptivity (and spectral emissivity at thermal equilibrium, according to Kirchhoff's law), is an important factor determining a system's efficiency and performance. Spectral absorptivity mediates the radiative heat transfer on the target surface. In particular, blackbody absorbers/emitters represent ideal surfaces with spectral emissivity of unity, thereby maximizing thermal radiative energy transfer. Achieving a real surface with properties as close as possible to an ideal blackbody emitter (otherwise known as a broadband emitter) is a goal for enhancing performance in the aforementioned applications.

### SUMMARY

One innovative aspect of the subject matter described in this disclosure can be implemented in a method including providing a material. A pulse fluence, a wavelength, a repetition rate, and a pulse duration of a laser pulse are specified, and a number of laser pulses is specified. The material is exposed to the specified number of laser pulses at the pulse fluence, the wavelength, the repetition rate, and the pulse duration. The material is translated and the exposing operation is repeated to form an x-y array of exposed areas on the material. Each exposed area is about 25 microns to 35 microns from each other exposed area.

Another innovative aspect of the subject matter described in this disclosure can be implemented in a structure of a surface of a material. The structure includes an x-y array of a substantially square pyramid-type protrusions. An apex of each of the substantially square pyramid-type protrusions is about 25 microns to 35 microns from each of the other substantially square pyramid-type protrusions. Each of the substantially square pyramid-type protrusions has a height of about 40 microns to 60 microns.

Another innovative aspect of the subject matter described in this disclosure can be implemented in a structure of a surface of a material. The structure includes an x-y array of a substantially square pyramid-type protrusions. An apex of each of the substantially square pyramid-type protrusions is about 25 microns to 35 microns from each of the other substantially square pyramid-type protrusions. Each of the substantially square pyramid-type protrusions has a height of about 40 microns to 60 microns. The material is tungsten carbide, molybdenum carbide, or tantalum. The structure has a spectral emissivity of about 0.90 or higher in about 0.3 microns to 15 microns wavelength range for a time period of up to at least about 100 hours at up to and including about 1000° C.

Details of one or more embodiments of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIGS. 1A and 1B show examples of schematic illustrations of the basis for enhanced light absorption to achieve near-blackbody surfaces.

FIG. 2 shows an example of a flow diagram illustrating a process for forming a laser-generated microstructure on a surface.

FIG. 3 shows an example of the optical setup for ultrafast femtosecond laser machining used to generate the surfaces described herein.

FIG. 4 shows an example of a schematic illustration of a scan pattern for ultrafast femtosecond laser machining.

FIG. 5 shows an example of a schematic illustration of a structure generated on a surface processed with ultrafast femtosecond laser machining.

FIGS. 6A-6F show examples of scanning electron micrographs of laser-generated microstructures of surfaces of different materials.

FIGS. 7A-7L show example of surface topology profiles of laser-generated microstructures of surfaces of different materials.

FIGS. 8A and 8B shows schematic illustrations of the aspect ratio of laser-generated microstructures. FIG. 8C shows an example of the aspect ratio of surface topology profiles of laser-generated microstructures of surfaces of different materials.

FIGS. 9A-9C shows examples of total spectral emissivity of laser-generated microstructures of surfaces of different materials.

FIG. 10A shows examples of spectrally integrated hemispherical average emissivity of laser-generated microstructures of surfaces of different materials at 0.3 μm to 15 μm. FIG. 10B shows examples of the directional average emissivity of laser-generated microstructures of surfaces of different materials.

### DETAILED DESCRIPTION

Reference will now be made in detail to some specific examples of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims.

In the following description, numerous specific details are set forth in order to provide a thorough understanding of the present invention. Particular example embodiments of the present invention may be implemented without some or all of these specific details. In other instances, well known process operations have not been described in detail in order not to unnecessarily obscure the present invention.

Various techniques and mechanisms of the present invention will sometimes be described in singular form for clarity. However, it should be noted that some embodiments include multiple iterations of a technique or multiple instantiations of a mechanism unless noted otherwise.

The terms “about” or “approximate” and the like are synonymous and are used to indicate that the value modified by the term has an understood range associated with it, where the range can be +20%, +15%, +10%, +5%, or +1%. The terms “substantially” and the like are used to indicate that a value is close to a targeted value, where close can mean, for example, the value is within 80% of the targeted value, within 85% of the targeted value, within 90% of the targeted value, within 95% of the targeted value, or within 99% of the targeted value.

Modern engineering strategies to achieve broadband emitters encompass various approaches, including the use of carbon-based materials and surface coatings on underlying substrates. Such strategies have limited capabilities, however, such as having intermediate emissivity under 0.9 or rapid thermal degradation at high temperatures. While metals have favorable thermomechanical properties such as high melting point, hardness, and ductility, their unmodified surfaces fail to provide enhanced thermal energy transfer due to low spectral emissivity in the infrared regime (e.g., spectral emissivity for Ta is less than 0.1 above 1 μm wavelength).

Laser fabrication techniques have been explored in the past as a means to tailor absorption/emission. Efforts to date using have focused on improving absorption in the visible/near-infrared wavelength (<2.5 μm), and have emphasized a relatively narrow wavelength range of interest. As such, new approaches are sought to extend the range into the mid-infrared (2.5 μm to 15 μm) to (i) improve absorption, (ii) extend the overall wavelength coverage, and (ii) improve thermal stability. Additionally, current constraints result in the inability of a broadband emitter designed for one specific device to be universally applicable to other systems, necessitating the exploration of novel material discovery pathways. In advanced applications, an effective broadband emitter requires near-unity spectral emissivity across different wavelength regimes, high thermal stability at elevated temperatures exceeding 1000° C., and a facile and scalable manufacturing process. Thus, the development of a versatile technique capable of fabricating blackbody surfaces on various materials becomes important from an engineering standpoint.

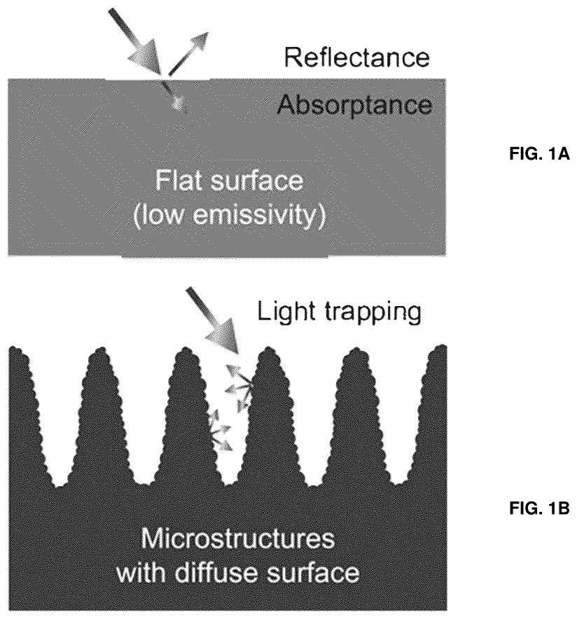

FIGS. 1A and 1B show examples of schematic illustrations of the basis for enhanced light absorption to achieve near-blackbody surfaces. FIG. 1A shows an example of a schematic illustration of emissivity of a flat surface. For such a non-transparent optically flat surface at the interface with air, incident light is either reflected or absorbed as a function of the complex refractive index. Any deviation in the material's refractive index from air (nₐᵢᵣ=1) results in an increase in the spectral reflectivity from zero and a decrease in the spectral emissivity from one. Moreover, the spectral emissivity in the infrared regime for metals is typically low (i.e., high reflectivity above 1 μm wavelength) because their dielectric functions proportionally increase with wavelength and inversely decrease with respect to angular frequency. As a result, a flat metal surface does not maximize the thermal radiative energy transport in the infrared wavelength regime.

The introduction of microstructures with rough surfaces can trap the incident light and scatter it within microcavities, leading to an augmentation in light absorption. FIG. 1B shows an example of a schematic illustration of emissivity of microstructures with a diffuse surface. The incident light can be trapped within microstructures whose length-scale is larger than the incident wavelength, resulting in the augmented light absorption. To fabricate such surface morphologies, an ultrafast femtosecond laser was employed to selectively ablate material from a surface, as described further herein.

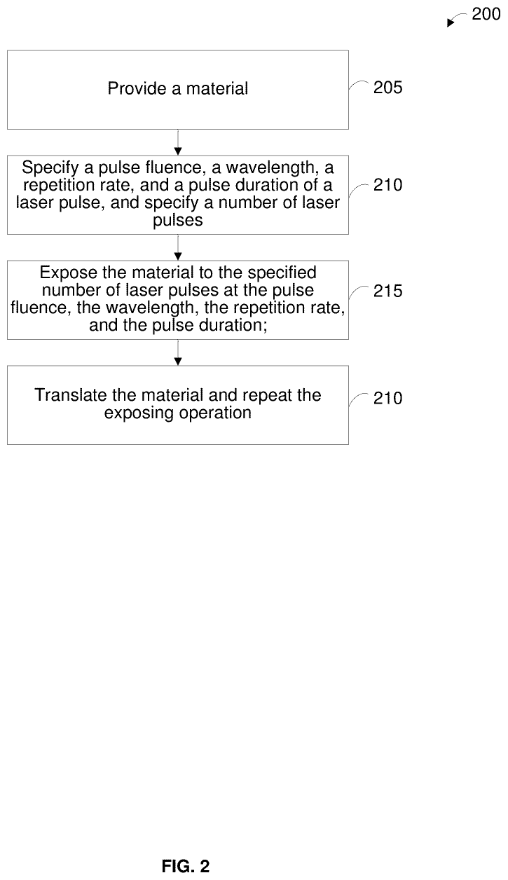

FIG. 2 shows an example of a flow diagram illustrating a process for forming a laser-generated microstructure on a surface. Starting at block 205 of the method 200, a material is provided. In some embodiments, the material is a material from a group a nickel-chromium-based superalloy, nickel, a nickel alloy, aluminum, zinc, niobium, tantalum, hafnium, a stainless steel, titanium, graphite, tungsten carbide, molybdenum carbide, and a carbon fiber composite.

At block 210, a pulse fluence, a wavelength, a repetition rate, and a pulse duration of a laser pulse are specified. The number of laser pulses to impart at a point or an area on the material is also specified.

At block 215, the material (specifically the point or area on the surface of the material) is exposed to the specified number of laser pulses at the pulse fluence, the wavelength, the repetition rate, and the pulse duration. In some embodiments, the pulse fluence is about 0.1 J/cm² to 10 J/cm², about 1 J/cm² to 3 J/cm², about 2 J/cm², or about 2.1 J/cm². In some embodiments, the wavelength is about 200 nanometers to 1500 nanometers, about 500 nanometers to 1500 nanometers, or about 1030 nanometers. In some embodiments, the repetition rate is about 1 kHz to 2000 kHz, about 50 kHz to 150 kHz, or about 100 kHz. In some embodiments, the pulse duration is about 10 femtoseconds to 2000 femtoseconds, about 250 femtoseconds to 750 femtoseconds, or about 500 femtoseconds. In some embodiments, the number of laser pulses is about 100 to 10000, about 1000 to 3000, or about 2000.

At block 220, the material is translated and the operation at block 215 is repeated. Blocks 215 and 220 are repeated to form an x-y array of exposed areas or points on the material, with each exposed area being about 25 microns to 35 microns from each other exposed area. In some embodiments, instead of translating the material, the laser pulses are translated.

In some embodiments, method 200 is performed in ambient air.

The method described with respect to FIG. 2 is referred to as a point drilling method. I.e., laser pulses impinge at a first point on a surface of a material, the material (or the laser beam) is translated, and laser pulses impinge at a second point on a surface of a material, without the further laser processing being performed at a point after the laser processing is performed at that point. A point drilling method is different from a raster scanning method. In a raster scanning method, some laser pulses impinge at a first point on a surface of a material, the material (or the laser beam) is translated, and laser pulses impinge at a second point on a surface of a material, but with additional laser pulses impinging at points on the surface (including the first point and the second point) one or more additional times during the laser processing.

Embodiments of the method described with respect to FIG. 2 generate a structure on the surface of a material. The structure includes an x-y array of a substantially square pyramid-type protrusions. An apex of each of the substantially square pyramid-type protrusions is about 25 microns to 35 microns from each of the other substantially square pyramid-type protrusions. Each of the substantially square pyramid-type protrusions has a height of about 40 microns to 60 microns. The structure may be envisioned as an egg-carton like structure.

In some embodiments, each of the substantially square pyramid-type protrusions has an aspect ratio of about 1.1 to 1.7. The aspect ratio is ratio of the width of the base of a substantially square pyramid-type protrusion to its height.

In some embodiments, the material is a material from a group a metal, a ceramic, and composites thereof. In some embodiments, the material is a material from a group a nickel-chromium-based superalloy, nickel, a nickel alloy, aluminum, zinc, niobium, tantalum, hafnium, a stainless steel, titanium, graphite, tungsten carbide, molybdenum carbide, and a carbon fiber composite.

In some embodiments, the structure further includes nanoparticles of the material disposed on the x-y array of a substantially square pyramid-type protrusions.

In some embodiments, a spectral emissivity of the structure is about 0.95 or higher in about 0.3 microns to 15 microns wavelength range. In some embodiments, a spectral emissivity of the structure is about 0.96 or higher in about 0.3 microns to 15 microns wavelength range.

In some embodiments, the material is tantalum, and a spectral emissivity of the structure is about 0.92 or higher in about 0.3 microns to 15 microns wavelength range for a time period of up to at least about 100 hours at a temperature up to and including about 1500° C. In some embodiments, the material is a nickel-chromium-based superalloy, and a spectral emissivity of the structure is about 0.93 or higher in about 0.3 microns to 15 microns wavelength range for a time period of up to at least about 100 hours at a temperature up to and including about 1000° C.

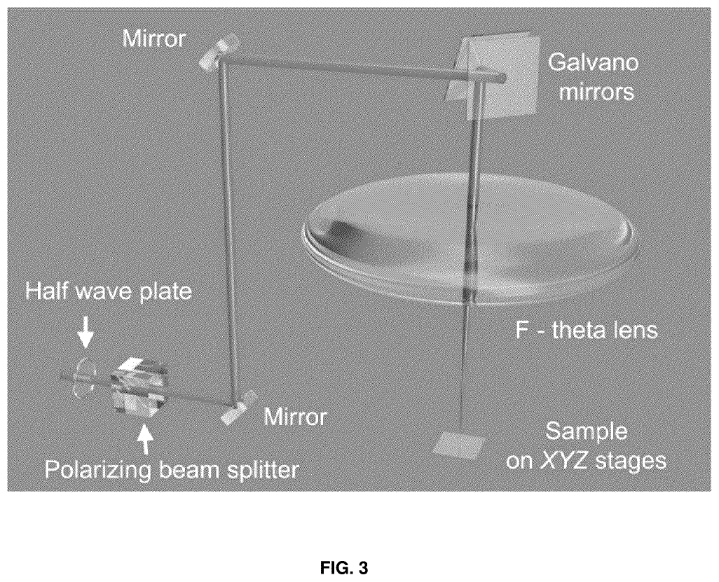

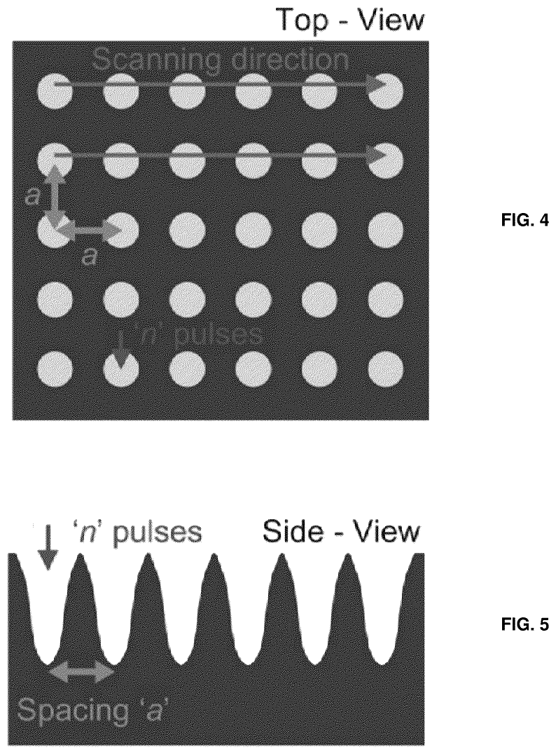

FIG. 3 shows an example of the optical setup for ultrafast femtosecond laser machining used to generate the surfaces described herein. Specifically, 500 femtosecond laser pulses at a 1030 nm wavelength operating at 100 kHz repetition rate were focused on material surfaces in ambient air. The incident laser power was 1.5 W, with the corresponding individual laser pulse fluence at 2.1 J/cm². A total of 2,000 fs laser pulses were imparted at a fixed location, and the same procedure was repeated at the next location separated by a spacing ‘a’ to process the entire surface area (FIG. 4). The laser was synchronized with a galvanometer scanner.

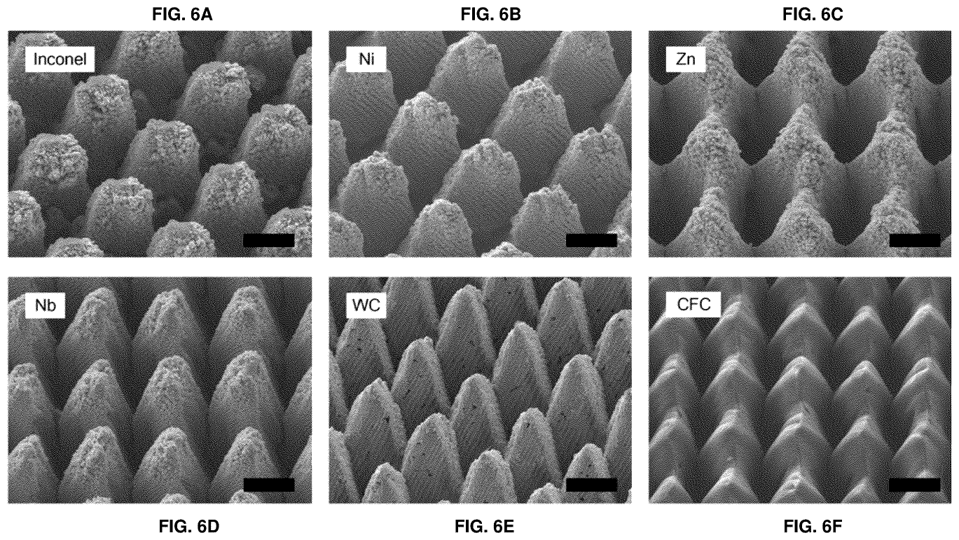

FIG. 4 shows an example of a schematic illustration of a scan pattern for ultrafast femtosecond laser machining. At a single location on the surface of the material, ‘n’ number of pulses were irradiated and separated by ‘a’ spacing. The spacing ‘a’ can be varied, for example, from 25 μm to 35 μm, depending on the type of materials due to different thermophysical properties. FIG. 5 shows an example of a schematic illustration of a structure generated on a surface processed with ultrafast femtosecond laser machining.

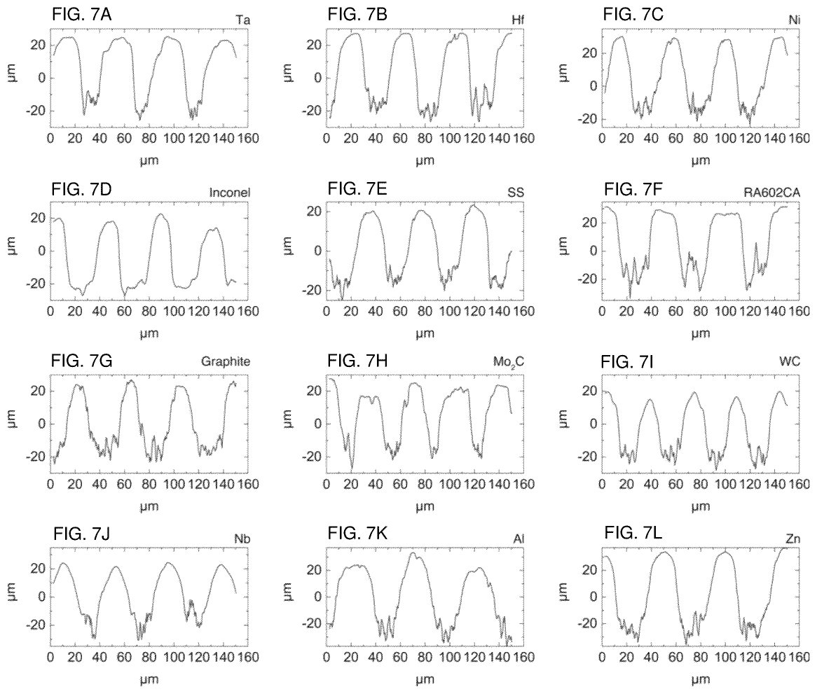

During femtosecond laser-material interactions, surface matter experiences melting and evaporation, and therefore conjugated ablation dynamics between molten liquid and plumes result in ejection of material in forms of plasma, nanoparticles, and ejecta streaks. Subsequently, the remnant materials are re-solidified into hierarchical microstructures decorated with microparticles or nanoparticles, as characterized by scanning electron microscopy. FIGS. 6A-6F show examples of scanning electron micrographs of laser-generated microstructures of surfaces of different materials. The different materials include Inconel, Ni, Zn, Nb, WC, and carbon fiber composite (CFC). As shown in FIGS. 6A-6F, similar surface geometries can be obtained on different types of substrates using nearly consistent laser processing parameters, due to the rapid energy deposition time of 500 femtosecond, which minimizes heat affected zones.

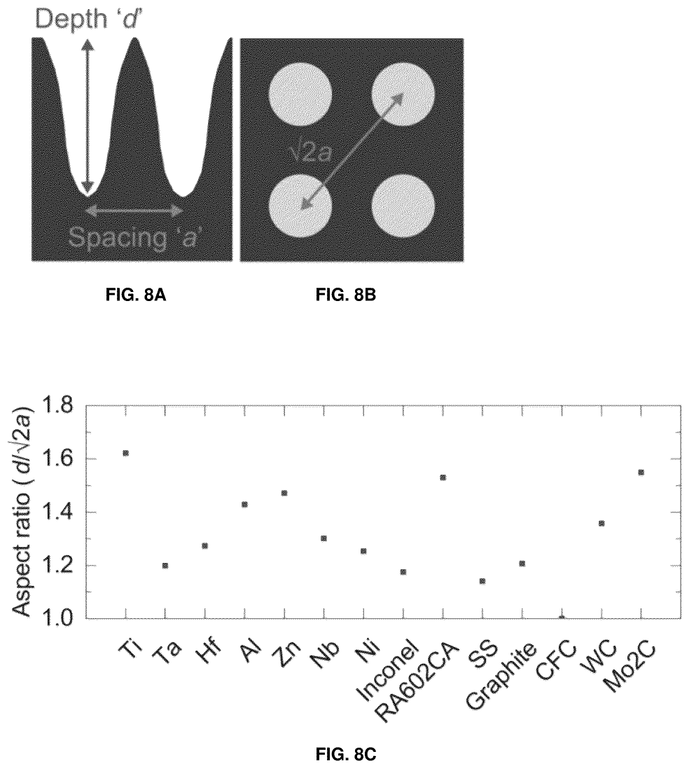

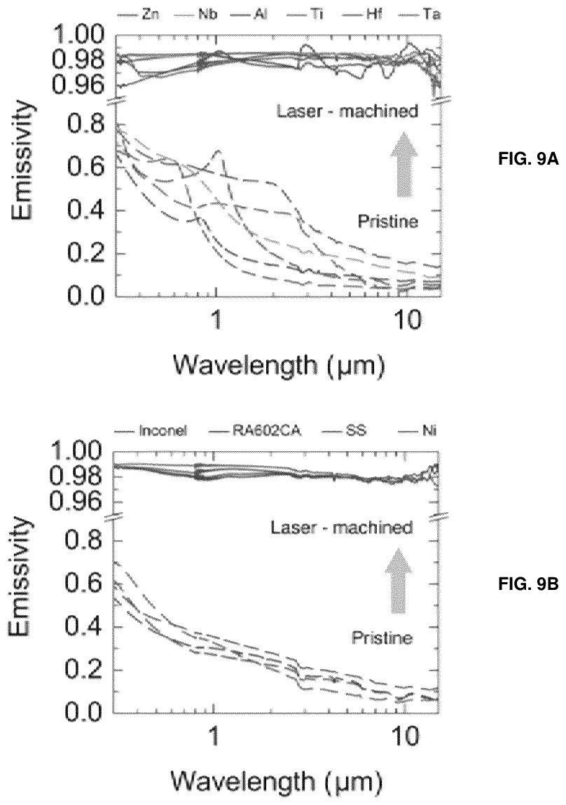

FIGS. 7A-7L show example of surface topology profiles of laser-generated microstructures of surfaces of different materials. FIGS. 8A and 8B shows schematic illustrations of the aspect ratio of laser-generated microstructures. FIG. 8C shows an example of the aspect ratio of surface topology profiles of laser-generated microstructures of surfaces of different materials. The recessed depths within the microcavities were in the range of 40 μm to 60 μm (aspect ratio ranges from 1.1 to 1.7), as measured by white light interferometry.

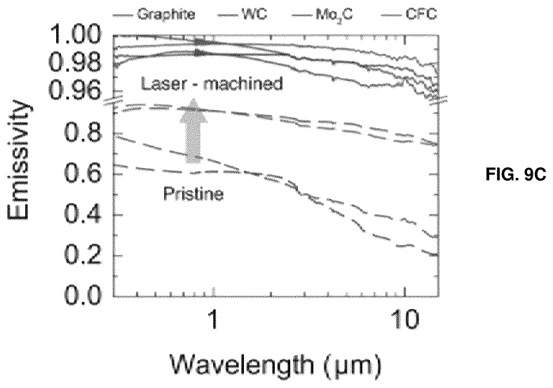

FIGS. 9A-9C shows examples of total spectral emissivity of laser-generated microstructures of surfaces of different materials. FIG. 9A shows the total spectral emissivity of laser-generated microstructures of surfaces and pristine flat surfaces for metals (Zn, Nb, Al, Ti, Hf, Ta). FIG. 9B shows the total spectral emissivity of laser-generated microstructures of surfaces and pristine flat surfaces for Ni/Ni-alloys (Inconel, RA602CA, SS, Ni). FIG. 9C shows the total spectral emissivity of laser-generated microstructures of surfaces and pristine flat surfaces for carbon materials (graphite, WC, Mo₂C, CFC). Pristine metal/metal alloys exhibited a spectral emissivity lower than 0.8, while carbon materials have a gray surface across the 0.3 μm to 15 μm wavelength range. Near-blackbody surfaces can be observed on all of the materials in shown in FIGS. 9A-9C due to the development of hierarchical surface geometries generated with the femtosecond laser processing.

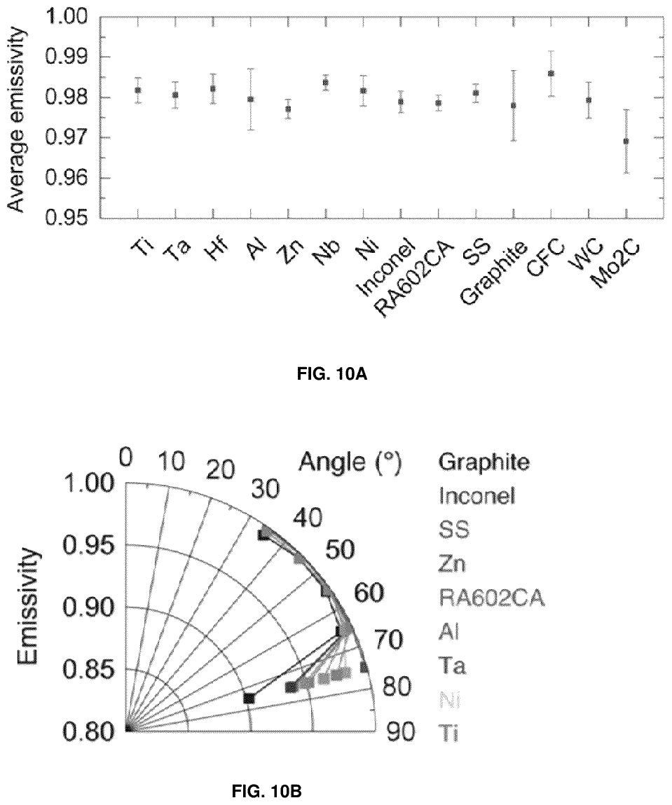

FIG. 10A shows examples of spectrally integrated hemispherical average emissivity of laser-generated microstructures of surfaces of different materials at 0.3 μm to 15 μm. The surfaces have a spectral emissivity higher than 0.96 within the same wavelength range after femtosecond laser processing, with an average emissivity exceeding 0.97. FIG. 10B shows an example of the directional average emissivity of laser-generated microstructures of surfaces of different materials. These angle-resolved average emissivity measurements indicated that the laser fabricated microstructures can omnidirectionally absorb incident light up to 75-degree angle.

### CONCLUSION

In the foregoing specification, the invention has been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

What is claimed is:

1. A method comprising:
providing a material;
specifying a pulse fluence, a wavelength, a repetition rate, and a pulse duration of a laser pulse, and specifying a number of laser pulses;
exposing the material to the specified number of laser pulses at the pulse fluence, the wavelength, the repetition rate, and the pulse duration; and
translating the material and repeating the exposing operation to form an x-y array of exposed areas on the material, with each exposed area being about 25 microns to 35 microns from each other exposed area.

2. The method of claim 1, wherein the material is a material from a group a nickel-chromium-based superalloy, nickel, a nickel alloy, aluminum, zinc, niobium, tantalum, hafnium, a stainless steel, titanium, graphite, tungsten carbide, molybdenum carbide, and a carbon fiber composite.

3. The method of claim 1, wherein the pulse fluence is about 0.1 J/cm² to 10 J/cm².

4. The method of claim 1, wherein the wavelength is about 200 nanometers to 1500 nanometers.

5. The method of claim 1, wherein the repetition rate is about 1 kHz to 2000 kHz.

6. The method of claim 1, wherein the pulse duration is about 10 femtoseconds to 2000 femtoseconds.

7. The method of claim 1, wherein the number of laser pulses is about 100 to 10000.

8. The method of claim 1, wherein the method is performed in ambient air.

9. A structure of a surface of a material, the structure comprising:
an x-y array of a substantially square pyramid-type protrusions, an apex of each of the substantially square pyramid-type protrusions being about 25 microns to 35 microns from each of the other substantially square pyramid-type protrusions, each of the substantially square pyramid-type protrusions having a height of about 40 microns to 60 microns.

10. The structure of claim 9, wherein each of the substantially square pyramid-type protrusions has an aspect ratio of about 1.1 to 1.7.

11. The structure of claim 9, wherein the material is a material from a group a metal, a ceramic, and composites thereof.

12. The structure of claim 9, wherein the material is a material from a group a nickel-chromium-based superalloy, nickel, a nickel alloy, aluminum, zinc, niobium, tantalum, hafnium, a stainless steel, titanium, graphite, tungsten carbide, molybdenum carbide, and a carbon fiber composite.

13. The structure of claim 9, further comprising:
nanoparticles of the material disposed on the x-y array of a substantially square pyramid-type protrusions.

14. The structure of claim 9, wherein a spectral emissivity of the structure is about 0.95 or higher in about 0.3 microns to 15 microns wavelength range.

15. The structure of claim 9, wherein a spectral emissivity of the structure is about 0.96 or higher from in 0.3 microns to 15 microns wavelength range.

16. The structure of claim 9, wherein the material is tantalum, and wherein a spectral emissivity of the structure is about 0.92 or higher in about 0.3 microns to 15 microns wavelength range for a time period of up to at least about 100 hours at a temperature up to and including about 1500° C.

17. The structure of claim 9, wherein the material is a nickel-chromium-based superalloy, and wherein a spectral emissivity of the structure is about 0.93 or higher in about 0.3 microns to 15 microns wavelength range for a time period of up to at least about 100 hours at a temperature up to and including about 1000° C.

18. A structure of a surface of a material, the structure comprising:
an x-y array of a substantially square pyramid-type protrusions, an apex of each of the substantially square pyramid-type protrusions being about 25 microns to 35 microns from each of the other substantially square pyramid-type protrusions, each of the substantially square pyramid-type protrusions having a height of about 40 microns to 60 microns, the material being tungsten carbide, molybdenum carbide, or tantalum, the structure having a spectral emissivity of about 0.90 or higher in about 0.3 microns to 15 microns wavelength range for a time period of up to at least about 100 hours at up to and including about 1000° C.
